(19) United States
(12) Patent Application Publication
(10) Pub. No.: US 2025/0139986 A1
(43) Pub. Date: May 1, 2025

(54) METHOD AND SYSTEM FOR PERCEIVING TRAFFIC ROAD ENVIRONMENT BASED ON GRAPH REPRESENTATION FOR AUTONOMOUS DRIVING

(71) Applicant: Korea Advanced Institute of Science and Technology, Daejeon (KR)

(72) Inventors: Dongsuk KUM, Daejeon (KR); Juyeb SHIN, Daejeon (KR)

(21) Appl. No.: 18/908,040

(22) Filed: Oct. 7, 2024

(30) Foreign Application Priority Data
Nov. 1, 2023 (KR) 10-2023-0149495
Mar. 29, 2024 (KR) 10-2024-0043159

(51) Int. Cl. G06V 20/58; G06F 16/901; G06T 3/4038

(52) U.S. Cl. CPC G06V 20/58; G06F 16/9024; G06T 3/4038; G06T 2207/20084; G06T 2207/30252

(57) ABSTRACT

Disclosed is a method and system for graph-based bird's-eye-view (BEV) driving environment perception for autonomous driving. A graph-based driving environment perception method for autonomous driving may include detecting driving environment objects on the road in a vector form; and modeling the driving environment objects from the vector form to a graph representation.

### RELATED APPLICATION(S)

This application claims priority under 35 U.S.C. § 119 or 365 to Korean Application No. 10-2023-0149495, filed Nov. 1, 2023 and Korean Patent Application No. 10-2024-0043159, filed Mar. 29, 2024. The entire teachings of the above application(s) are incorporated herein by reference.

### BACKGROUND

### 1. Field of the Invention

Example embodiments relate to driving environment perception technology for autonomous driving.

### 2. Related Art

Currently, according to an increase in the demand for automobile intelligence technology, such as autonomous driving and an advanced driver assistance system (ADAS), the importance of driving environment perception technology, such as lanes and crosswalks around a vehicle is emerging for technology advancement.

Surrounding environment perception technology through simple lane detection has limitation in advancing autonomous driving technology (e.g., level 4/4+). Also, for autonomous driving enabling global scalability, localization technology based on a road map (high-definition (HD) map) that does not rely on a satellite navigation system, for example, a global positioning system (GPS), is being emphasized.

For example, Korean Patent Laid-Open Publication No. 10-2023-0108776 (published on Jul. 19, 2023) describes technology for generating an autonomous driving route of a vehicle.

For HD map-based localization, there is a need to perceive a surround-view road driving environment in a format similar to that of an HD map. Here, the HD map format defines a driving environment in a three-dimensional (3D) vectorized space.

The existing camera-based driving environment 3D perception technology is developing into segmentation technology that rasterizes a bird's-eye-view (BEV) space. However, in the case of segmentation, according to an increase in the size of a perception area and a map, data becomes heavier and it is not suitable for comparison with the HD map.

### SUMMARY

Example embodiments provide driving environment perception technology in a three-dimensional (3D) vectorized form that is lightweight and suitable for localization through matching with a high-definition (HD) map to overcome the limitation found in driving environment perception technology using segmentation.

According to an example embodiment, there is provided a graph-based driving environment perception method of a computer device including at least one processor, the graph-based driving environment perception method including detecting, by the at least one processor, driving environment objects on the road in a vector form.

According to an aspect, the graph-based driving environment perception method may further include modeling, by the at least one processor, the driving environment objects from the vector form to a graph form.

According to another aspect, the detecting may include extracting an image feature map from multi-view camera input; and transforming the image feature map into a bird's-eye-view (BEV) space expressed in vehicular coordinate system using at least one of a convolutional neural network (CNN), a multi-layer perceptron (MLP), and a cross-attention.

According to still another aspect, the detecting may include detecting geometric information of the driving environment objects, semantic information indicating object types, and instance information indicating object classification through graph representation.

According to still another aspect, the modeling may include transforming points and lines constituting a vector of the driving environment objects to the graph form expressed with nodes and edges that represent connectivity of the nodes.

According to still another aspect, the modeling may include modeling polylines of map elements to a graph with bidirectional edges.

According to still another aspect, the detecting may include detecting vertices and edges that constitute a graph from a BEV feature map extracted from multi-view camera input; and computing a graph adjacency matrix using the vertices and the edges.

According to still another aspect, the detecting of the vertices and the edges may include detecting the vertices and the edges that constitute map elements through a CNN decoder using the BEV feature map.

According to still another aspect, the computing of the graph adjacency matrix may include representing graph node embeddings by combining the vertices and the edges; and predicting connection between nodes as an adjacency matrix, based on similarity between the nodes.

According to still another aspect, the representing may include complementing positional information of the vertices by adding local directional information as embedding of a distance transform patch corresponding to the same grid cell of the BEV feature map.

According to still another aspect, the predicting may include computing the similarity through interaction between nodes using an attention-based graph neural network (GNN).

According to still another aspect, the predicting may include computing an adjacency score between nodes with cosine similarity of a node embedding vector.

According to an example embodiment, there is provided a computer device including at least one processor configured to execute computer-readable instructions, wherein the at least one processor causes the computer device to detect driving environment objects on the road in a vector form, and to model the driving environment objects from the vector form to a graph form.

According to an example embodiment, there is a non-transitory computer-readable recording medium storing instructions that, when executed by a processor, cause the processor to execute a graph-based driving environment perception method including detecting driving environment objects on the road in a vector form; and modeling the driving environment objects from the vector form to a graph form.

According to example embodiments, it is possible to perform camera-based localization with a BEV driving environment perception model using a 3D vectorized form and, through this, to implement camera-based level 3/4 autonomous driving.

According to example embodiments, it is possible to perform accurate and fast perception through a graph modeling of vectorized driving environment objects and a perception system consisting GNN which is suitable for vectors, and to be efficiently used in downstream autonomous driving technology.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating an example of an internal configuration of a computer device according to an example embodiment;

FIG. 2 illustrates an example of describing a graph-based surround-view driving environment perception method according to an example embodiment;

FIG. 3 illustrates an example of a graph modeling process of road driving environment object vectors according to an example embodiment;

FIG. 4 illustrates an example of a surround-view road driving environment perception deep learning network according to an example embodiment;

FIG. 5 illustrates an example of details of a surround-view road driving environment perception deep learning architecture according to an example embodiment;

FIG. 6 illustrates an example of an adjacency matrix indicating connection between nodes according to an example embodiment; and

FIG. 7 shows performance comparison of camera input models and performance comparison of various sensor input (modality) models.

### DETAILED DESCRIPTION

Hereinafter, example embodiments will be described in detail with reference to the accompanying drawings.

The example embodiments relate to driving environment perception technology for autonomous driving.

The example embodiments including the detailed disclosures herein may easily perform scalability in autonomous driving through lighter and faster computation compared to rasterized segmentation and to perform localization through map matching in a format similar to that of a high-definition (HD) map, using a three-dimensional (3D) vectorized form for driving environment perception.

A graph-based driving environment perception system according to example embodiments may be implemented by at least one computer device and a graph-based driving environment perception method according to example embodiments may be performed through the at least one computer device included in the graph-based driving environment perception system. Here, a computer program according to an example embodiment may be installed and run on the computer device and the computer device may perform the graph-based driving environment perception method according to example embodiments under control of the running computer program. The aforementioned computer program may be stored in computer-readable recording media to execute the graph-based driving environment perception method on the computer device in conjunction with the computer device.

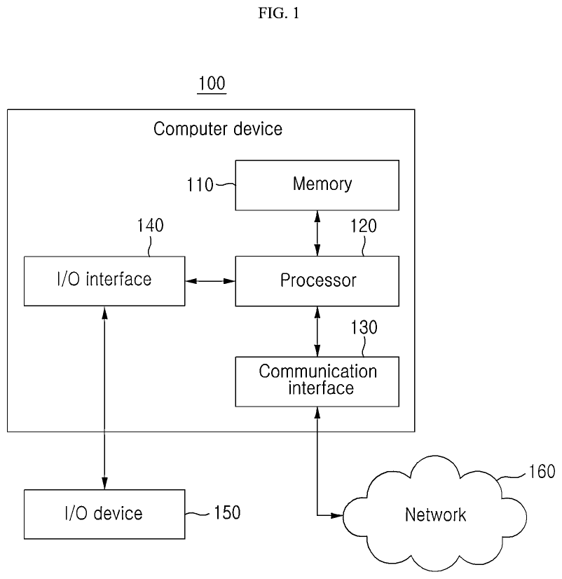

FIG. 1 is a block diagram illustrating an example of a computer device according to an example embodiment. For example, a graph-based driving environment perception system according to example embodiments may be implemented by a computer device 100 of FIG. 1.

Referring to FIG. 1, the computer device 100 may include a memory 110, a processor 120, a communication interface 130, and an input/output (I/O) interface 140 as components to execute a graph-based driving environment perception method according to example embodiments.

The memory 110 may include, as computer-readable recording media, a permanent mass storage device such as random access memory (RAM), read only memory (ROM), and disk drive. Here, the permanent mass storage device, such as ROM and disk drive, may be included in the computer device 100 as a separate permanent storage device from the memory 110. Also, an operating system (OS) and at least one program code may be stored in the memory 110. Such software components may be loaded to the memory 110 from computer-readable recording media separate from the memory 110. Examples of the separate computer-readable recording media may include computer-readable recording media, such as a floppy drive, a disk, a tape, a DVD/CD-ROM drive, and a memory card. In another example embodiment, software components may be loaded to the memory 110 through the communication interface 130, rather than the computer-readable recording media. For example, the software components may be loaded to the memory 110 of the computer device 100 based on a computer program installed by files received through a network 160.

The processor 120 may be configured to process an instruction of a computer program by performing basic arithmetic, logic, and I/O operations. The instruction may be provided from the memory 110 or the communication interface 130 to the processor 120. For example, the processor 120 may be configured to execute the received instruction according to a program code stored in a storage device, such as the memory 110.

The communication interface 130 may provide a function for communication between the computer device 100 and another apparatus through the network 160. For example, a request or an instruction created by the processor 120 of the computer device 100 according to a program code stored in a storage device such as the memory 110, data, and a file may be delivered to other apparatuses over the network 160 under control of the communication interface 130. Inversely, a signal or an instruction, data, and a file from includer apparatus may be received at the computer device 100 through the communication 130 of the computer device 100 over the network 160. The received signal or instruction and data may be delivered to the processor 120 or the memory 110 through the communication interface 130 and the file may be stored in a storage medium (the aforementioned permanent storage device) further includable in the computer device 100.

The communication scheme is not limited and may include a near field wired/wireless communication between devices as well as a communication scheme using a communication network (e.g., mobile communication network, wired Internet, wireless Internet, and broadcasting network) includable in the network 160. For example, the network 160 may include at least one network among networks that include a personal area network (PAN), a local area network (LAN), a campus area network (CAN), a metropolitan area network (MAN), a wide area network (WAN), a broadband network (BBN), and the Internet. Also, the network 160 may include at least one of network topologies that include a bus network, a star network, a ring network, a mesh network, a star-bus network, and a tree or hierarchical network, but is not limited thereto.

The I/O interface 140 may be a device for interfacing with an I/O device 150. For example, an input device may include a device, such as a microphone, a keyboard, a camera, and a mouse, and an output device my include a device, such as a display and a speaker. As another example, the I/O interface 140 may be a device for interfacing with a device in which an input function and an output function are integrated into a single function, such as a touchscreen. The I/O device 150 may be configured as a single device with the computer device 100.

Also, in other example embodiments, the computer device 100 may include a greater or smaller number of components than the number of components shown in FIG. 1. However, there is no need to clearly illustrate many conventional components. For example, the computer device 100 may be implemented to include at least a portion of the I/O device 150 or may further include other components, such as a transceiver, a camera, various sensors, and a database.

Hereinafter, detailed example embodiments of graph-based bird's-eye-view (BEV) driving environment perception technology for autonomous driving are described.

The example embodiments aim to provide vectorized driving environment perception technology that is suitable for position perception through lightweight computation and matching with an HD map to overcome the limitation found in the existing driving environment perception technology using segmentation.

The vectorized representation of a driving environment implicitly provides geometric information of driving objects, such as lines of the road, road markings, and signs, object type (semantic), and object classification (instance) information.

The vectorized form is readily applicable to scalability in autonomous driving through light and fast computation compared to rasterized segmentation and may also perform localization through map matching in a format similar to that of an HD map.

Herein, the example embodiments propose vectorized driving environment object detection methodology and perception system including the following characteristics:

(1) The vector form represents geometric information including points and lines and may need to represent various forms of road objects that may appear in a driving environment.

(2) The vector form may represent object classification information from the connectivity of points and lines, thereby overcoming the limitation of segmentation output that only includes object type information.

To output various types and sizes of driving environment vectors from fixed-size sensor input, the existing driving environment perception technology applies a model that requires a large computational amount, such as postprocessing and recursive structure.

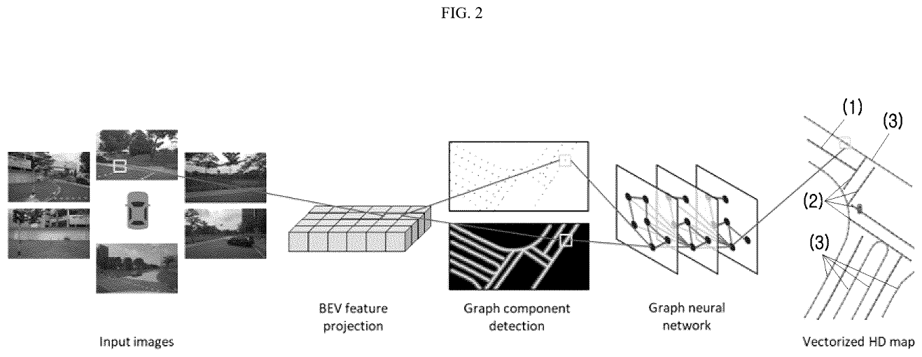

FIG. 2 illustrates an example of describing a graph-based surround-view driving environment perception method according to an example embodiment.

Herein, proposed is driving environment perception technology that may perform fast computation and have high scalability in autonomous driving technology, while including all of class and object classification information by representing a vector form including points and lines in a graph representation.

Understanding static environment of surroundings is one of essential techniques for deploying autonomous driving. Recent approaches focus on detecting HD map elements online from on-board sensor observation, which is named online HD map construction.

An existing online HD map construction network associates observation values of on-board sensors, such as a camera and/or LiDAR, and predicts static components of a map. HD map construction is presented as a rasterized segmentation problem, assigning occupancy score to a rasterized BEV grid. These approaches are memory intensive and lack a structural relationship desirable for downstream tasks, such as trajectory planning and motion forecasting. Therefore, technology for reconstructing vectorized representation of maps that are lighter and readily applicable to autonomous driving is being researched.

The example embodiment relates to providing an instance-level graph modeling for fast HD map construction and may predict map elements as a set of structured polylines from a set of cameras mounted to a vehicle.

Referring to FIG. 2, a hybrid architecture (hereinafter, ‘InstaGraM’) of convolutional neural networks (CNNs) and a graph neural network (GNN) for real-time HD map learning of BEV representation includes three stages as follows: (1) CNN feature maps are extracted from each input image captured by a camera component and are aggregated into a single top-down feature map using a 2D-to-BEV transformation network. (2) Vertex points and edge maps of road elements are detected through CNNs using the top-down feature map. (3) Positions of vertices and their respective local edge maps are transferred to an attention-based GNN to predict their instance-level connection as an adjacency matrix trained in a supervised manner.

That is, InstaGraM may start from input multi-view images and camera parameters, may project image features, and may extract a unified BEV representation by projecting and fusing images features. InstaGraM extracts vertex positions and implicit edge maps of map elements. Here, final vectorized HD map elements are generated through the GNN.

The example embodiments include (1) a novel graph modeling for vectorized polylines of map elements. This model models geometric, semantic, and instance-level information as graph representation. (2) On top of the proposed graph modeling, InstaGraM designed for real-time performance is presented.

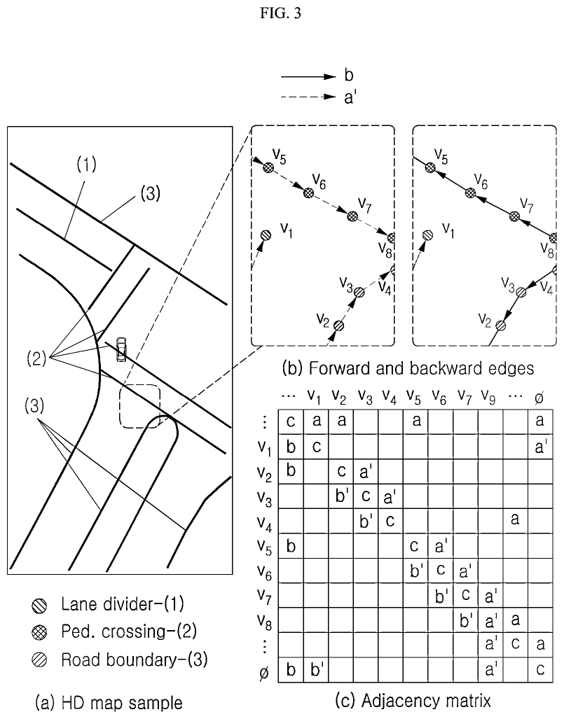

FIG. 3 illustrates an example of a graph modeling process of road driving environment object vectors according to an example embodiment.

Initially, the example embodiment may transform a driving environment object in a vector form to a graph form and thereby represent the same. Referring to FIG. 3, after transforming points and lines that constitute a driving environment object vector to the graph form expressed with nodes and edges that represent connectivity of the nodes, coordinates and connectivity of the nodes in the BEV space may be extracted through a deep learning network.

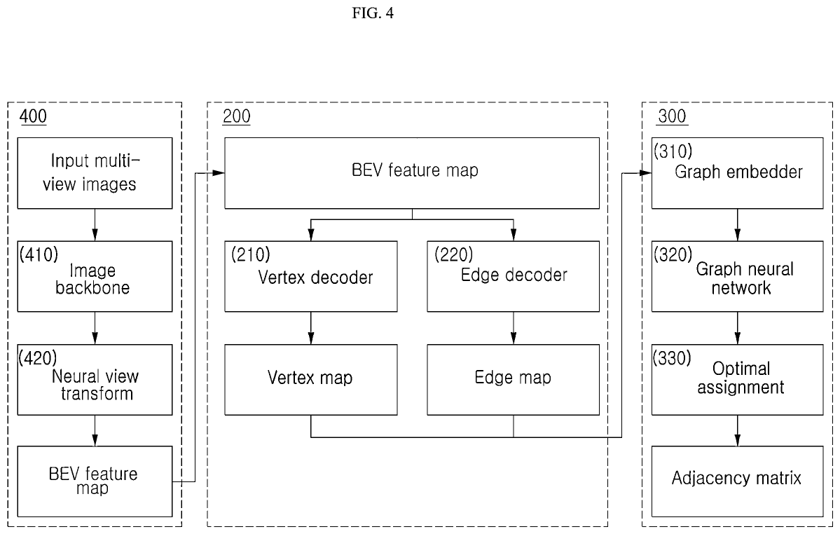

FIG. 4 illustrates an example of a surround-view road driving environment perception deep learning network (i.e., InstaGraM) according to an example embodiment.

Referring to FIG. 4, a surround-view driving environment deep learning network based on a graph modeling scheme may largely include a BEV feature map extractor 400, a graph element detector 200, and a graph adjacency matrix calculator 300.

The BEV feature map extractor 400 may extract an image feature map from multi-view camera input through an image backbone 410. Here, since the feature map has two-dimensional (2D) information projected onto the image plane, a neural view transformer 420 may transform the image feature map to a BEV space of a vehicular coordinate system. Here, a CNN-based depth information prediction, multi-layer perception (MLP), and a cross-attention may be used for the transform method.

The graph element detector 200 serves to detect a vertex map and an edge map. A vertex decoder 210 and an edge decoder 220 may detect coordinates of a vertex point and an edge map constituting a graph through a CNN, respectively, from the BEV feature map transformed through the BEV feature map extractor 400.

The graph adjacency matrix calculator 300 may represent a graph node embedding using a graph embedder 310 by fusing vertex coordinates and edge information extracted by the graph element detector 200. The graph adjacency matrix calculator 300 may compute similarity through interaction between nodes using a GNN 320. An optimal assignment 330 predicts connection between nodes as an adjacency matrix with likelihood, based on the similarity. Here, the adjacency matrix may be designed to detect a bidirectional edge by allowing two connections (forward and backward edges) per single node as shown in (b) of FIG. 3.

Hereinafter, a detailed process of acquiring a vectorized representation of an HD map from a set of cameras mounted to a vehicle is described.

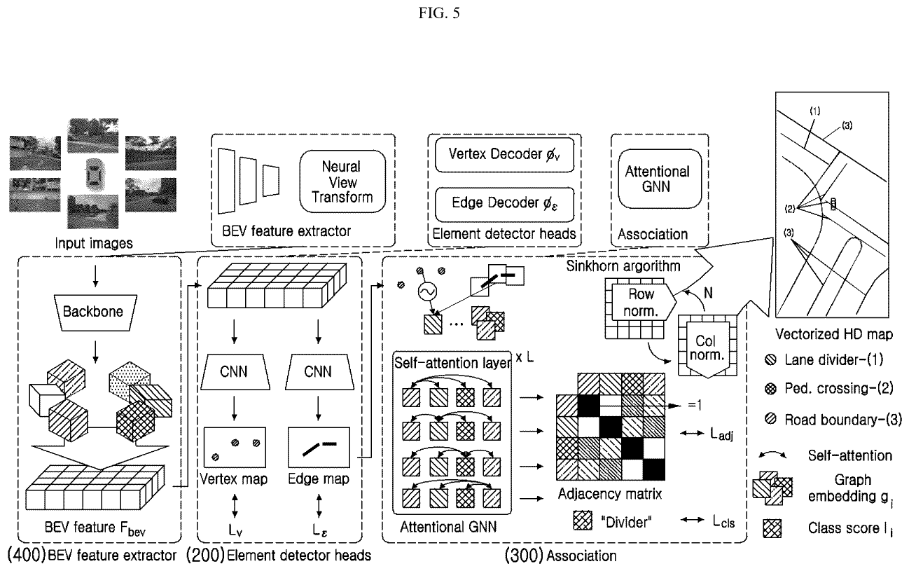

FIG. 5 illustrates an example of details of a surround-view road driving environment perception deep learning architecture according to an example embodiment. FIG. 5 illustrates an example of performing driving environment perception technology using a dataset (e.g., nuScenes) that includes cameras and HD maps acquired from various areas (e.g., Boston, Singapore, etc.) and driving environments (e.g., day, night, rain, etc.).

The example embodiment uses a method of transforming a BEV feature map using an MLP through multi-view camera input and then detecting a driving environment object using a graph element detection using a CNN and a GNN using self-attention.

### Neural View Transform

A first stage of an HD map estimation network is extracting a top-down BEV feature map [symbol] _{bev} by combining CNN features of each image captured by a camera component at a specific point in time. InstaGraM may be applied to the conventional BEV feature transform method.

### Graph Element Detection

Vertices and edges of HD map elements are extracted from the top-down feature map [symbol] _{bev} using two CNN decoders, ϕᵥ and ϕ_{ε}, respectively. The corresponding two components are predicted in a rasterized BEV space [symbol] ^{W}^{_{bev}}^{×H}^{_{bev}} similar to segmentation tasks. The vertex decoder ϕᵥ adopts an interest point decoder from and extracts a possible position heatmap at every 8×8 local, non-overlapping grid in BEV pixels. It is computed as

$$𝒳 ∈ {ℝ}^{\frac{{W}_{bev}}{8} \times \frac{{H}_{bev}}{8} \times 65} ,$$

and 65 channels indicate possible positions in local grids with an additional “no vertex” dustbin. After channel-wise softmax, the dustbin dimension is removed and the vertex heatmap is reconstructed from

$${ℝ}^{\frac{{W}_{bev}}{8} \times \frac{{H}_{bev}}{8} \times 64}$$

to [symbol] ^{W}^{_{bev}}^{×H}^{_{bev}}. In parallel with the vertex decoder, the edge map decoder ϕ_{ε} predicts a distance transform map [symbol] ∈ [symbol] ^{W}^{_{bev}}^{×H}^{_{bev}}^{×3} three channels indicating the number of class categories of map elements. The edge map of distance transform implicitly provides spatial relation between vertices and directional information of map elements. Also, the distance transform representation plays a significant role in instance-level association. By applying ReLU and threshold after a last Conv layer, distance values from 0 to 10 are predicted from a rasterized BEV image.

### Association Through GNN

Two components extracted from the graph element detector 200 are connected through a graph neural network and all vertices interact through attention mechanism. Through this, point-level and instance-level relations between map elements may be inferred based on various attributes that include positions, implicit edge map of distances values, and class categories.

Graph embeddings: Initial graph embeddings are formed by combining vertex positions and distance transform maps. Initially, a position of each vertex in the rasterized BEV coordinates and its corresponding confidence are extracted from channel-wise softmax in a vertex position heatmap, which is represented as vᵢ=(xᵢ, yᵢ, cᵢ). Only a distinctive vertex position with maximum confidence is extracted in each 8×8 grid cell, which acts similarly to non-maximum suppression. After extraction, an i-th vertex position vᵢ is encoded by a sinusoidal positional encoding function γ to augment it into a high-dimensional vector. This positional encoding is further supported by additional shallow MLP. To complement positional information of the vertex vᵢ, local directional information is additionally included as embedding of the distance transform patch dᵢ corresponding to the same grid cell. Then, an initial graph includes D-dimensional embeddings ⁰gᵢ ∈ [symbol] ^{D}, combining both the vertex position and corresponding local directional information.

$${}^{( 0 )} {g}_{i} = {MLP}_{V} ( γ ( {v}_{i} ) ) + {MLP}_{ε} ( {d}_{i} ) \qquad [ Equation 1 ]$$

Through this, a plurality of graph embeddings may be associated based on vertex and edge representation through an attention mechanism.

Attentional message passing: It starts with an initial graph ⁽⁰⁾ [symbol] with nodes that include a vertex position and edge map embeddings as a high-dimensional vector. The initial graph has bidirectional edges, connecting a vertex i to all other vertices. To further enhance nodes and to find final edges of vertices, the initial graph is delivered to an attention graph neural network and this graph is propagated through message passing. The present invention aims to find final bidirectional edges of the vertices as instance-level information of map elements. The initial graph is fed to the attention graph neural network that aggregates graph embeddings through message passing including MLP and multi-head self attention (MSA).

$${}^{( 0 )} 𝒢 = [ {}^{( 0 )} {g}_{1} ; {}^{( 0 )} {g}_{2} ; … ; {}^{( 0 )} {g}_{𝒩} ] \qquad [ Equation 2 ]$$

$${}^{( l )} 𝒢 = {}^{( l - 1 )} 𝒢 + MLP ( [ {}^{( l - 1 )} 𝒢 ‖ MSA {(}^{( l - 1 )} 𝒢 ) ] ) , l = 1 , … , L )$$

Self-attention and aggregation in Equation 2 provides interaction between all graph embeddings based on their spatial and directional appearances included in gᵢ. In detail, each vertex node pays attention to all other nodes to find next possible vertices that may appear in the map. After L layers of attentional aggregation, class scores lᵢ ∈ [symbol] ³ and graph matching embeddings fᵢ ∈ [symbol] ^{D} are acquired.

$${l}_{i} = {MLP}_{c l s} ( {}^{( L )} {g}_{i} ) \qquad [ Equation 3 ]$$

$${f}_{i} = {MLP}_{match} {(}^{( L )} {g}_{i} )$$

Adjacency matrix: Optimal edges are predicted by computing score matrix Ŝ∈ [symbol] between nodes of the graph ^{(L)} [symbol] . The adjacency score between nodes i and j may be computed as cosine similarity of embedding vectors.

$${\hat{S}}_{i j} = 〈 {f}_{i} , {f}_{j} 〉 , ∀ \{ i , j \} ∈ 𝒩 \times 𝒩 \qquad [ Equation 4 ]$$

Here, <·,·> denotes inner product of two embeddings. This score matrix is augmented to S̅∈ [symbol] with a dustbin node for vertices that may not have any match, that is, a vertex at the end of an element instance. The Sinkhorn algorithm that iteratively normalizes exp(S̅) along rows and columns is used to compute the final adjacency matrix of the graph. The adjacency matrix Â∈ [symbol] may be computed through optimal matching with augmented score Ŝ.

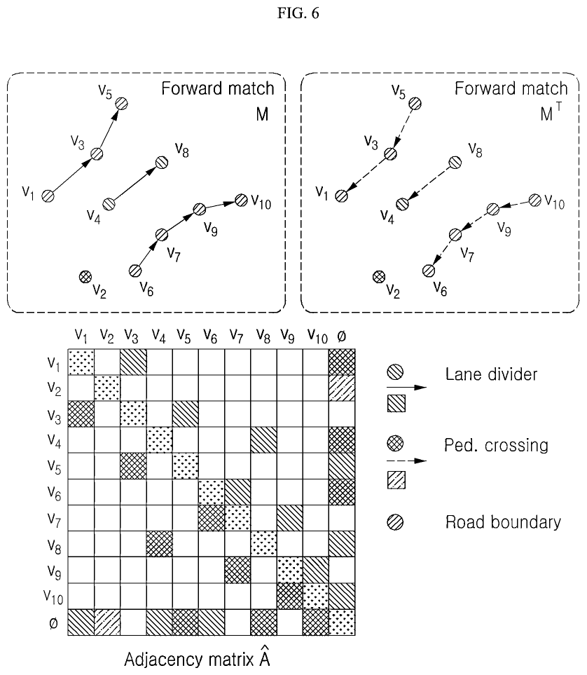

FIG. 6 illustrates an example of an adjacency matrix and may model polylines of map elements to a graph with bidirectional edges.

### Loss Function

By designing the entire network to be differentiable, it may be trained in a fully supervised manner using loss combination at a plurality of branches. For supervision of the graph element detector 200, cross-entropy loss with softmax loss and L2 loss is used for vertex position heatmap and distance transform map, respectively.

$${ℒ}_{V} ( 𝒳 , 𝒴 ) = \frac{1}{{H}_{c} {W}_{c}} {\sum }_{h = 1 , w = 1}^{{H}_{c} , {W}_{c}} {l}_{p} ( {x}_{h w} ; {y}_{h w} ) \qquad [ Equation 5 ]$$

$${ℒ}_{ε} ( \hat{𝒟} , 𝒟 ) = \frac{1}{N} {\sum }_{{d}_{p} ∈ 𝒟} {‖ {d}_{p} - {\hat{d}}_{p} ‖}^{2}$$

Here,

$${H}_{c} = \frac{{H}_{bev}}{8} and {W}_{c} = \frac{{W}_{bev}}{8}$$

are indexing dimensions of 8×8 local cells.

Coordinates from vertex position heatmap prediction may not perfectly match ground truth (GT) vertex coordinates in an early stage of learning. Therefore, GT adjacency and GT ambiguity of a class label may arise. To address this, a nearest pair between GT vertices and predicted vertices may be found to provide the GT for output of a graph neural network, an adjacency matrix, and class prediction. The nearest GT vertex σ(i) to the predicted vertex i is acquired by minimizing Chamfer distance cost with threshold D₀.

$$σ = {arg min}_{D ( {v}_{i} , {v}_{σ ( i )} ) < {D}_{0}} {\sum }_{i}^{𝒩} D ( {v}_{i} , {v}_{σ ( i )} ) \qquad [ Equation 6 ]$$

From matching pairs [vᵢ, v_{σ(i)}], GT adjacency pairs [symbol] ={(i,j)}∈ [symbol] between vertices i and j are acquired by observing connection between GT vertices σ(i) and σ(j). A predicted vertex without a GT pair is Ø and belongs to GT adjacency (e.g., v₂ of FIG. 6). Since the vectorized representation of the map has bidirectional edges, negative log-likelihood of bidirectional loss for both for and backward directions is computed. It is performed in both directions [symbol] ={(i, j)}∈ [symbol] and [symbol] ^{T}={(j, i)}∈ [symbol] .

$${ℒ}_{adj} = - \frac{1}{2} ( {\sum }_{( i , j ) ∈ ℳ} log {\overline{A}}_{i j} + {\sum }_{( i , j ) ∈ {ℳ}^{T}} log {\overline{A}}_{i j} ) \qquad [ Equation 7 ]$$

In the example embodiment, the graph neural network is additionally trained with negative log-likelihood for vertex classification. Through this supervision, in the example embodiment, the graph neural network may infer vertex label categories in addition to instance-level information.

$${ℒ}_{cls} = {\sum }_{i}^{𝒩} log {l}_{σ ( i )} \qquad [ Equation 8 ]$$

By adding the loss function, a final loss function is defined as follows.

$$ℒ = {λ}_{1} {ℒ}_{V} + {λ}_{2} {ℒ}_{ε} + {λ}_{3} {ℒ}_{adj} + {λ}_{4} {ℒ}_{cls} \qquad [ Equation 9 ]$$

Here, by setting this λ₃, λ₄<<λ₁, λ₂, the graph neural network may have enough vertex predictions to perform association in the early stage of training.

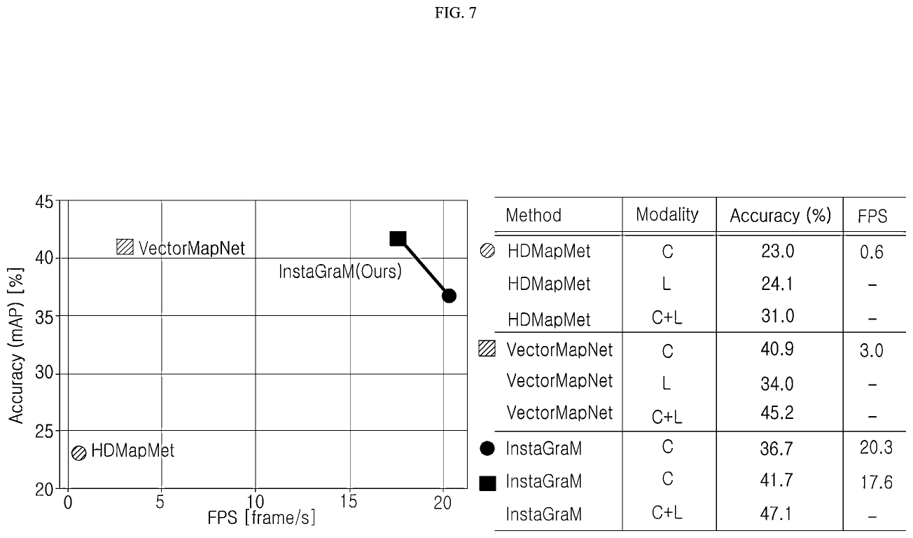

FIG. 7 shows performance comparison of camera input models (drawing on the left) and performance comparison of various sensor input (modality) models (drawing on the right). An autonomous driving dataset (nuScenes) shows that InstaGraM of the present invention achieves very fast speed and high performance compared to the conventional method. In particular, it can be seen that the performance of a camera-based mode of the present invention is higher than that of a model that receives a LiDAR sensor as input. Also, InstaGraM may efficiently fuse with a heterogenous sensor, such as the LiDAR sensor.

InstaGraM according to an example embodiment operates robustly on cloudy day, clear day, rainy day, and at night.

According to example embodiments, it is possible to perform camera-based localization using a BEV driving environment perception model and, through this, perform camera-based level 3/4 autonomous driving. Low-cost camera sensors are widely installed in commercial vehicles, enabling commercialization of driving environment perception and camera-based localization. Output of a driving environment perception system according to an example embodiment is expressed in a lightweight form in the same format as that of an HD map, making it easy for global scalability.

According to example embodiments, it is possible to perform accurate and fast perception through a graph transform method of vectorized driving environment objects and a GNN-based perception system suitable for the same, and to be efficiently used in low-level autonomous driving technology. The graph transform method disclosed herein includes all of geometric, object type, and object classification information on driving environment vectors and may recognize a driving environment through a fast computation using a GNN suitable for the same. The graph transform method may be efficiently used in low-level autonomous driving technology, such as trajectory planning and route forecasting, through driving environment perception that includes geometric, object type, and object classification information on driving environment vectors, and to be efficiently operable in cognitive areas with various sizes due to characteristics of the GNN.

The systems or the apparatuses described herein may be implemented using hardware components, software components, and/or combination of the hardware components and the software components. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, computer storage medium or device, to provide instructions or data to the processing device or be interpreted by the processing device. The software also may be distributed over network coupled computer systems so that the software is stored and executed in a distributed fashion. The software and data may be stored in one or more computer readable storage mediums.

The methods according to the example embodiments may be recorded in non-transitory computer-readable media including program instructions to be performed through various computer methods. Here, the media may continuously store a computer-executable program or may temporarily store the same for execution or download. Also, the media may be various recording devices or storage devices in which a single piece of hardware or a plurality of hardware is combined and may be distributed over a network without being limited to media directly connected to a computer system. Examples of non-transitory computer-readable media include magnetic media such as hard disks, floppy disks, and magnetic tapes; optical media such as CD ROM disks and DVDs; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A graph-based driving environment perception method of a computer device comprising at least one processor, the graph-based driving environment perception method comprising:
detecting, by the at least one processor, driving environment objects on the road in a vector form.

2. The graph-based driving environment perception method of claim 1, further comprising:
modeling, by the at least one processor, the driving environment objects from the vector form to a graph representation.

3. The graph-based driving environment perception method of claim 1, wherein the detecting comprises:
extracting an image feature map from multi-view camera input; and
transforming the image feature map to a bird's-eye-view (BEV) space of a vehicular coordinate system using at least one of a convolutional neural network (CNN), a multi-layer perceptron (MLP), and a cross-attention.

4. The graph-based driving environment perception method of claim 1, wherein the detecting comprises detecting geometric information of the driving environment objects, semantic information indicating object types, and instance information indicating object classification through graph representation.

5. The graph-based driving environment perception method of claim 2, wherein the modeling comprises transforming points and lines constituting a vector of the driving environment objects to the graph representation expressed with nodes and edges that represent connectivity of the nodes.

6. The graph-based driving environment perception method of claim 2, wherein the modeling comprises modeling polylines of map elements to a graph with bidirectional edges.

7. The graph-based driving environment perception method of claim 1, wherein the detecting comprises:
detecting vertices and edges that constitute a graph from a BEV feature map extracted from multi-view camera input; and
computing a graph adjacency matrix using the vertices and the edges.

8. The graph-based driving environment perception method of claim 7, wherein the detecting of the vertices and the edges comprises detecting the vertices and the edges that map elements consist of, through a CNN decoder using the BEV feature map.

9. The graph-based driving environment perception method of claim 7, wherein the computing of the graph adjacency matrix comprises:
representing graph node embeddings by combining the vertices and the edges; and
predicting connection between nodes as an adjacency matrix with likelihood, based on similarity between the nodes.

10. The graph-based driving environment perception method of claim 9, wherein the representing comprises complementing positional information of the vertices by adding local directional information as embedding of a distance transform patch corresponding to the same grid cell of the BEV feature map.

11. The graph-based driving environment perception method of claim 9, wherein the predicting comprises computing the similarity through interaction between nodes using an attention-based graph neural network (GNN).

12. The graph-based driving environment perception method of claim 9, wherein the predicting comprises computing an adjacency score between nodes with cosine similarity of a node embedding vector.

13. A computer device comprising:
at least one processor configured to execute computer-readable instructions,
wherein the at least one processor causes the computer device to,
detect driving environment objects on the road in a vector form, and
model the driving environment objects from the vector form to a graph representation.

14. The computer device of claim 13, wherein the at least one processor causes the computer device to,
extract an image feature map from multi-view camera input, and
transform the image feature map to a bird's-eye-view (BEV) space of a vehicular coordinate system.

15. The computer device of claim 13, wherein the at least one processor causes the computer device to detect geometric information of the driving environment objects, semantic information indicating object types, and instance information indicating object classification through graph representation.

16. The computer device of claim 13, wherein the at least one processor causes the computer device to transform points and lines constituting a vector of the driving environment objects to the graph representation expressed with nodes and edges that represents connectivity of the nodes.

17. The computer device of claim 13, wherein the at least one processor causes the computer device to model polylines of map elements as a graph with bidirectional edges.

18. The computer device of claim 13, wherein the at least one processor causes the computer device to,
detect vertices and edges that constitute a graph from a BEV feature map extracted from multi-view camera input, and
compute a graph adjacency matrix using the vertices and the edges.

19. The computer device of claim 18, wherein the at least one processor causes the computer device to,
detect the vertices and the edges that are map elements through a convolutional neural network (CNN) decoder using the BEV feature map,
represent graph node embeddings by combining the vertices and the edges, and
predict connection between nodes as an adjacency matrix with likelihood, based on similarity between the nodes.

20. A non-transitory computer-readable recording medium storing instructions that, when executed by a processor, cause the processor to execute a graph-based driving environment perception method comprising:
detecting driving environment objects on the road in a vector form; and
modeling the driving environment objects from the vector form to a graph representation.
